(19) United States
(12) Patent Application Publication
(10) Pub. No.: US 2022/0135194 A1
(43) Pub. Date: May 5, 2022

(54) Retention Or Storage Apparatus And Associated Systems

(71) Applicant: Kardoes, Titonka, IA (US)

(72) Inventors: Nathan Kardoes, Titonka, IA (US); Anthony Kardoes, Titonka, IA (US)

(21) Appl. No.: 17/519,354

(22) Filed: Nov. 4, 2021

Related U.S. Application Data
(60) Provisional application No. 63/109,938, filed on Nov. 5, 2020.

(51) Int. Cl. B63C 15/00; F16M 11/26; F16B 2/08

(52) U.S. Cl. CPC B63C 15/00; F16B 2/08; F16M 11/26

(57) ABSTRACT

Disclosed herein is a storage apparatus including a cradle defining an opening, a vertical support having a first end and a second end, where the first end of the of the vertical support is fixedly attached to the cradle, and a horizontal support, where the horizontal member is attached to the vertical support at the second end of the vertical support, wherein a stored item rests within the cradle for storage. The storage apparatus may also include a retention device operatively engaged with the horizontal support, wherein the retention device is configured to encircle the stored item and hold the stored item against the horizontal support. The retention device may include a ratchet strap.

CROSS-REFERENCE TO RELATED APPLICATION(S)

This application claims the benefit under 35 U.S.C. § 119(e) to U.S. Provisional Application 63/109,938, filed Nov. 5, 2020, and entitled Retention or Storage Apparatus and Associated Systems, which is hereby incorporated herein by reference in its entirety for all purposes.

### FIELD

This application relates generally to devices and systems for holding and storing large, elongate and/or bulky items, including, for example, watersport equipment such as kayaks.

### BACKGROUND

Various kayak and water sport equipment holders and storage systems are known in the art. Many known storage solutions are cumbersome, take up valuable space in areas, such as docks, and may be difficult or dangerous to use.

### BRIEF SUMMARY

Disclosed herein is a storage system that attaches to a dock or other location to store kayaks, canoes, floating mats, and various other items. In various implementations, the storage system attaches to the side of a dock so as to leave the dock space open.

In Example 1, a storage apparatus comprising a cradle defining an opening, a vertical support having a first end and a second end, where the first end of the of the vertical support is attached to the cradle, and a horizontal support, where the horizontal member is attached to the vertical support at the second end of the vertical support, wherein the cradle is configured to hold an item for storage.

Example 2 relates to the storage apparatus of Example 1, further comprising a retention device operatively engaged with the horizontal support, wherein the retention device is configured to encircle the stored item and hold the stored item against the horizontal support.

Example 3 relates to the storage apparatus of Example 2, wherein the retention device comprises a ratchet strap.

Example 4 relates to the storage apparatus of Examples 1-3, wherein the vertical support is a telescoping member.

Example 5 relates to the storage apparatus of Examples 1-4, wherein the cradle, the vertical support, and the horizontal support are modular and configured for releasable engagement with each other.

Example 6 relates to the storage apparatus of Examples 1-4, wherein the cradle, the vertical support, and the horizontal support are unitary.

Example 7 relates to the storage apparatus of Examples 1-6, further comprising a bumper disposed on the horizontal support.

Example 8 relates to the storage apparatus of Examples 1-7, further comprising a liner disposed on the cradle.

Example 9 relates to the storage apparatus of Examples 1-8, further comprising at least one of a dock anchor, a wall anchor, a sand stake, an edge anchor, and a free-standing support for engagement with the vertical support.

In Example 10, a storage apparatus comprising: an elongate member, a cradle engaged with the elongate member at a first end, a first horizontal member engaged with the elongate member at a second end, and at least one attachment anchor, wherein the cradle, first horizontal member, and elongate member are configured to hold a secured item for storage.

Example 11 relates to the storage apparatus of Example 10, wherein the cradle is slidably engaged with the elongate member to be capable of being disposed along the first end at two or more elevations.

Example 12 relates to the storage apparatus of Examples 10-11, wherein the first horizontal member is slidably engaged with the elongate member to be capable of being disposed along the second end at two or more elevations.

Example 13 relates to the storage apparatus of Examples 10-12, further comprising a second horizonal member engaged with the elongate member between the first horizonal member and the cradle.

Example 14 relates to the storage apparatus of Examples 10-13, further comprising a retention device engaged with the first horizontal member, wherein the retention device is configured to encircle the secured item and hold the secured item against the horizontal member.

Example 15 relates to the storage apparatus of Examples 10-14, wherein the first horizontal member further comprises a bumper, wherein the bumper is disposed between the horizontal member and the secured item to protect the secured item.

Example 16 relates to the storage apparatus of Examples 10-15, wherein the attachment anchor is a dock anchor and wherein the storage apparatus is configured to be fixedly attached to a side of a dock.

Example 17 relates to the storage apparatus of Examples 10-16, wherein the cradle further comprises a liner.

Example 18 relates to the storage apparatus of Examples 10-17, wherein the retention device comprises at least one of a ratchet strap, a cam strap, a hook and loop mechanism, a buckle, and Velcro.

Example 19 relates to the storage apparatus of Examples 10-18, wherein the retention device comprises a ratchet strap.

In Example 20, a storage device for securing an item comprising an elongate vertical member, a cradle operatively engaged at a first end of the elongate vertical member, the cradle comprising a liner for cushioning the item when the item is secured in the cradle, a horizontal member operatively engaged at a second end of the elongate vertical member, the horizontal member comprising a cushion for cushioning the item when the item is against the horizontal member, a retention device disposed on the horizontal member configured to encircle the item when the item is in the cradle and against the horizontal member, and a dock anchor operatively engaged with the storage device configured for securing the storage device to a docket via one or more fasteners.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a perspective view of the storage apparatus with a kayak, according to one implementation.

FIG. 2 is perspective view of the storage apparatus on a dock, according to one implementation.

FIG. 3 is a top view of the cradle, according to one implementation.

FIG. 4 is a front view of a telescoping vertical support, according to one implementation.

FIG. 5 is a perspective view of a horizontal support, according to one implementation.

FIG. 6A is a partial rear view of a horizontal support, according to one implementation.

FIG. 6B is a partial rear view of a horizontal support, according to one implementation.

FIG. 7 is a perspective view of the storage apparatus with a kayak, according to one implementation.

FIG. 8A shows a dock attachment bracket, according to one implementation.

FIG. 8B shows a wall attachment bracket, according to one implementation.

FIG. 8C shows a sand stake, according to one implementation.

FIG. 8D shows a edge anchor, according to one implementation.

FIG. 8E shows a free standing support and attachment bracket, according to one implementation.

### DETAILED DESCRIPTION

Various implementations of the disclosed storage apparatus are configured for storage of kayaks, canoes, floating mats, or other items. In certain implementations, the storage apparatus can be installed or otherwise disposed on and used at a dock. The storage apparatus may be optimized to use none or only a small amount of space on the dock to maximize the efficiency of storage of the item at or near the water without impeding the dock space itself. Various further implementations allow for efficient and space saving storage of various watersport equipment in a variety of locations, including but not limited to on a beach or mounted to a wall. Further implementations allow for free-standing storage. It would be appreciated that the various configurations of the device disclosed and contemplated herein provide the benefit of easy and efficient storage of items that may otherwise be difficult of cumbersome to store.

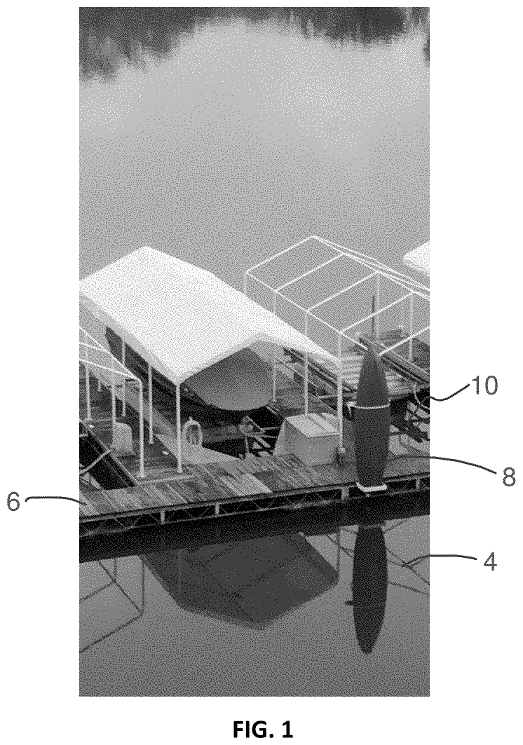

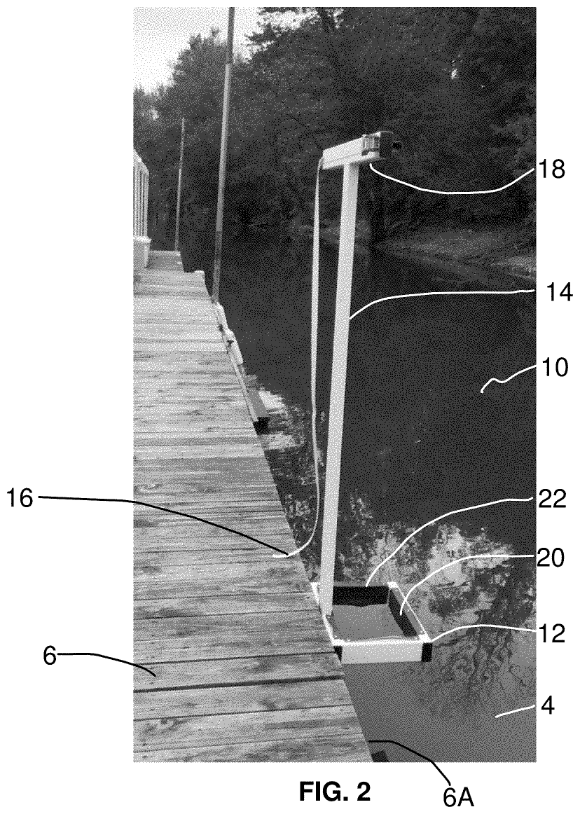

Turning now to the figures, FIGS. 1-2 show an exemplary implementation of the storage apparatus 10 mounted on a dock 6, such as to overhang the water 4, at least in part. That is, instead of being disposed above the dock 6 surface, the storage apparatus 10 and the item 8 retained thereon is disposed above the water 4. This type of suspended configuration allows easy access for users to insert or remove items from the storage apparatus 10 while minimizing the amount of space on and above the dock 6 surface that is occupied by the apparatus 10 and the stored item 8. Various implementations described herein will reference a kayak 8 as the stored item, but those of skill in the art would appreciate that a plurality of alternative items may be stored or retained using the storage apparatus 10 described herein.

As would be appreciated, and as can be seen in FIG. 1, dock 6 space is valuable and must serve a multitude of purposes, including, but not limited to, water access, boat access, a thoroughfare, equipment storage, and other uses. Because dock 6 space, including the space above the dock 6 surface, is valuable and often limited, bulky and/or large items of recreational equipment are often stored off the dock 6, such as in a garage or on a rack attached to a vehicle, such as a car, camper, or truck. These off-dock locations may be far from the dock 6, requiring that a person carry these large, bulky and often elongate and/or heavy items to and from the dock 6 before and after each use. Such traveling with and/or transporting of these items can be taxing on the user and may contribute to damage to the items themselves as they may be dropped, bumped into objects, or otherwise mishandled on these journeys. As can be seen in FIGS. 1 and 2, the storage apparatus 10 allows for these bulky and/or large items to be stored at the point of use—at the water 4—without forfeiting valuable dock 6 space.

Further, vertical storage provided by the storage apparatus 10 may be advantageous because kayaks 8 should not be stored on solid, flat surfaces for extended periods of time, as this type of storage could damage and/or deform the kayak 8 over time. This type of vertical storage, as disclosed or contemplated herein, provides further space savings compared to known horizontal storage solutions. Still further, the implemented vertical storage may further provide and allow for adequate drainage and drying for times that may be wet when placed in storage, or that may become wet during storage outdoors. That is water may be shed more easily from items stored in a vertical orientation thereby preventing pooling water, rot, and/or other damage that may occur due to prolonged periods of being wet/damp or having pooled, standing water, as would be understood.

Turning to FIG. 2, in various implementations, the storage apparatus 10 includes a cradle 12, an elongate vertical support 14, a retention device 16, and/or a horizontal support 18. The storage apparatus 10 is configured such that a kayak 8 or other item can be stored in a vertical position, with one end of the item resting in or on the cradle 12. In further implementations, the item is optionally supported by leaning or resting against the vertical support 14 and/or horizontal support 18. In a still further implementation, the retention device 16—such as a tie down or rachet strap 16—is wrapped around the kayak 8 and engaged with the horizontal support 18 such as to secure the kayak 8 to the storage apparatus 10.

In certain implementations, the storage apparatus 10 is modular such that the cradle 12, elongate vertical support 14, and horizontal support 18 are separate components that are selectively attachable and detachable from one another. The modular storage apparatus 10 is capable of easier transportation and shipment.

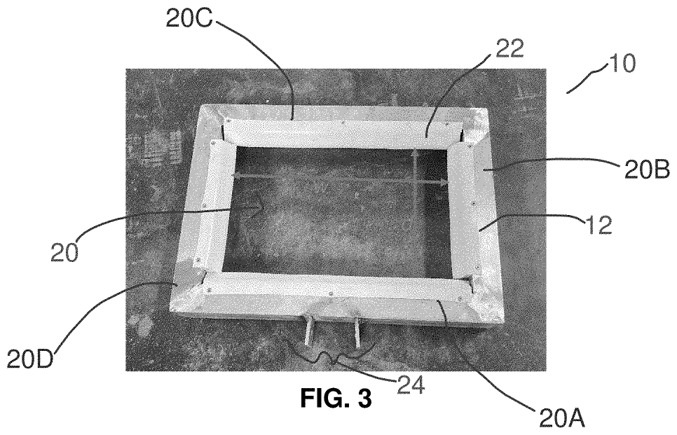

In various implementations, the cradle 12 is substantially rectangular, such as shown in FIGS. 2 and 3. Various alternative shapes are, of course, possible, such as, but not limited to, square, oval, circular, or rounded polygon. In certain implementations, the depth (d) of the cradle 12 may be between about twelve (12) inches and about twenty-two (22) inches. The width (w) of the cradle 12 may be between about eighteen (18) inches and about twenty-six (26) inches. In one specific example, the cradle 12 may have a depth (d) of about sixteen (16) inches and a width (w) of about twenty-two (22) inches. As would be appreciated, the size and shape of the cradle 12 may be varied depending on the intended usage and the item to be stored/retained.

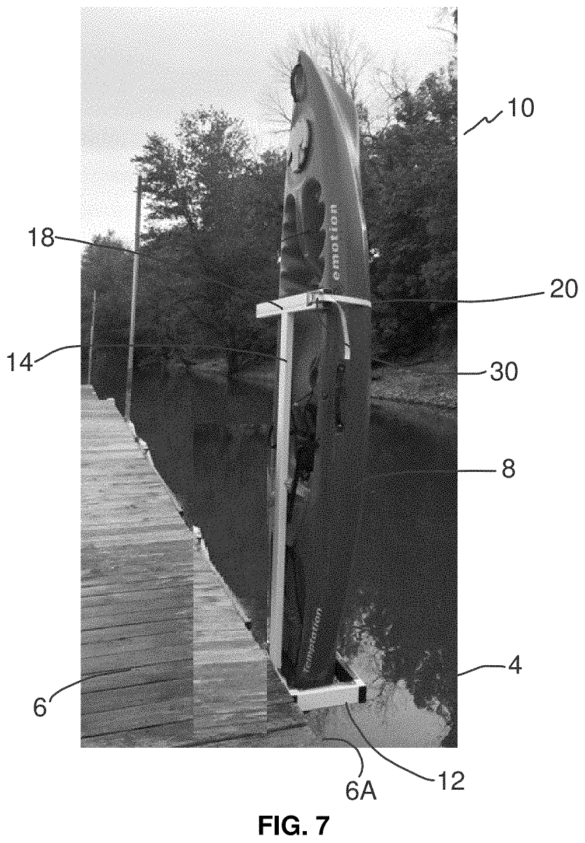

In various implementations, the cradle 12 defines an opening 20. In these implementations, the opening 20 is shaped such that one end of a kayak 8 may be disposed in or inserted through the opening 20 with the sides of the kayak 8 resting against the cradle 12, as shown in FIGS. 1 and 7. In various alternative implementations, the cradle 12 may include a platform (not shown) covering the opening 20 and creating a substantially flat plane upon which an item or items may rest. In certain implementations, the platform may be a modular or detachable component such that it may be removed from or placed on the cradle 12 only when desired. In some alternative implementations, the cradle 12 is solely a platform such that no opening 20 exists within the cradle 12.

In certain implementations, the cradle 12 and/or platform are formed from a rigid material, such as metal, aluminum, plastic, or other materials or combinations thereof as appreciated by those of skill in the art.

In various implementations, the cradle 12 is covered, at least in part, with a liner 22. More specifically, one or more or each of the four sides 20A, 20B, 20C, 20D of the cradle 12 has a liner 22 attached thereto or disposed thereon. In certain implementations, the liner 22 is provided to be disposed between the kayak 8 and each of the four sides 20A-20D so as to protect the kayak 8 and/or the storage apparatus 10 from damage caused by direct contact between the kayak 8 and the cradle 12. In further implementations, the liner 22 may optionally increase friction between a kayak 8 and the cradle 12 such as to provide a more secure hold. The liner 22 may be formed from rubber, foam, plastic, PVC lines, outdoor carpeting, or other appropriate materials or combinations thereof as would be appreciated. Various alternative materials would be appreciated by those of skill in the art.

As shown in FIG. 3, in certain implementations, the cradle 12 includes an attachment device (or “bracket”) 24 to engage with the vertical support 14. In these implementations, the cradle 12 and storage apparatus 14 may be connected via the bracket 24, such that the storage apparatus 10 may be modular. That is, the bracket 24 (and thus the cradle 12) is detachable. In various alternative implementations, the cradle 12 and vertical support 14 are integral, shown for example in FIG. 2, such that the cradle 12 is not detachable. In some implementations, the attachment device 24 can be any such known device or fastener mechanism, such as bolts, a clamp, any other known device/mechanism, and/or via welding or other permanent form of connection, as would be understood.

In further implementations, the bracket 24 is configured to be slidably engaged with the vertical support 14, such that the cradle 12 may be disposed at a variety of elevations with respect to the vertical support 14. In certain implementations, one or more openings may be formed within the vertical support 14 for attachment to the cradle 12 at various heights. Alternatively, the cradle 12 may attach to the vertical support 14 via a frictional hold at any elevation.

In certain implementations, the vertical support 14 is a rigid elongate member. The vertical support 14 may be attached to the cradle 12 such that the vertical support 14 is substantially perpendicular to the cradle 12. In various implementations, the vertical support 14 may have a length between about seventy-two (72) inches and ninety-six (96) inches. In one specific example, the vertical support 14 is about eighty (80) inches in length. Of course, various alternative lengths are possible and contemplated herein based on the type of item to be stored/retained and other variable factors.

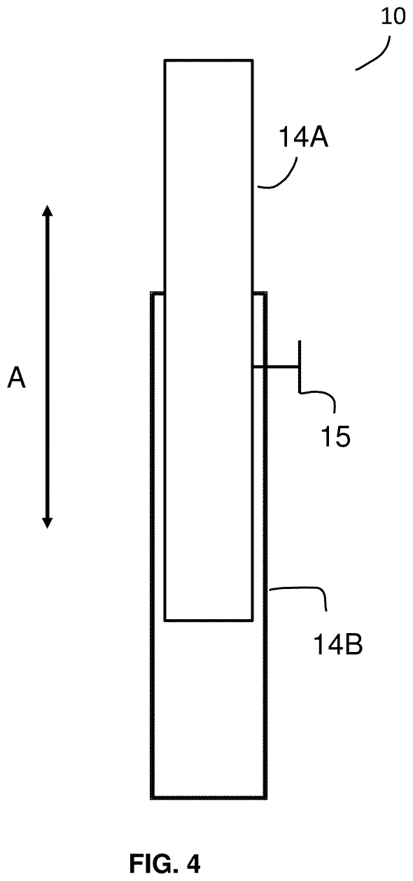

As shown in FIG. 4, the vertical support 14 may be telescoping elongate member 14, according to some implementations. In these and other implementations, a first elongate portion 14A may be fitted within a second elongate portion 14B such that the first elongate portion 14A is slidable within the second elongate portion 14B in the directions of reference arrow A. Further, in these and other implementations, the length of the telescoping vertical support 14 may be fixed via a frictional hold or via a bolt 15 and opening configuration, as would be appreciated. The telescoping vertical support 14 may allow for the storage apparatus 10 to be configured to hold different items of various sizes with minimal change to the configuration of the apparatus 10.

In various implementations, the storage apparatus 10 includes a horizontal support 18 attached to the vertical support 14, shown individually in FIG. 5. In various implementations, the horizontal support 18 is a rigid elongate member. In certain implementations, the horizontal support 18 is engaged with the vertical support 14, such that the horizontal support 14 is substantially perpendicular to the vertical support 14. The horizontal support 18 may be between about twenty (20) inches and forty-two (42) inches in length. In one specific example the horizontal support is about thirty-five (35) inches long. Various alternative lengths are possible as would be understood by those of skill in the art.

According to various embodiments, the horizontal support 18 is engaged with the vertical support 14 at or near one end of the vertical support 14, which is typically the top end when the apparatus 10 is attached to the dock 6 or other structure. In various alternative implementations, as will be discussed further below, the horizontal support 18 may be engaged with the vertical support 14 at any point along the vertical support 14. In certain implementations, more than one horizontal support 18 may be used.

As seen in FIG. 5, the horizontal support 18 may have an attachment device (or “bracket”) 26 for coupling to the vertical support 14. FIGS. 5A-5B show exemplary implementations of the horizontal support 18 connected to the vertical support 14 via the bracket 26. The discussion of the attachment device 24 set forth above, including, for example, the features, various embodiments, and relationship with the vertical support 14, etc. also applies to the attachment device 26. This type of connection may further include one or more bolts to affix the horizontal support 18 to the vertical support 14. In various alternative implementations, the horizontal support 18 and vertical support 14 may be integral and/or permanently attached to each other such as via welding or other method, as would be understood.

In certain implementations, the bracket 26 is configured to be slidably engaged with the vertical support 14, such that the horizontal support 18 may be disposed at a variety of elevations with respect to the vertical support 14. In certain implementations, one or more openings may be formed within the vertical support 14 for attachment to the horizontal support 18 at various heights. Alternatively, the horizontal support 18 may attach to the vertical support 14 via a frictional hold at any elevation.

As shown in FIGS. 2 and 5, in various implementations, the horizontal support 18 includes a bumper 32 or other protrusion 32. In these implementations, the bumper 32 is shaped and arranged to engage the kayak 8 and/or provide a cushion between the kayak 8 and the horizontal support 18, such that as the kayak 8 is secured on the storage apparatus 10, the horizontal support 18 does not damage the kayak 8. In further implementations, the bumper 32 may extend from the horizontal member 18 such as to span any gap that may be located between the horizontal member 18 and the kayak 8, for a more secure hold and therefore storage.

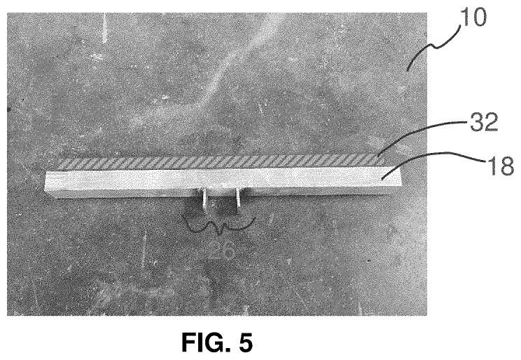

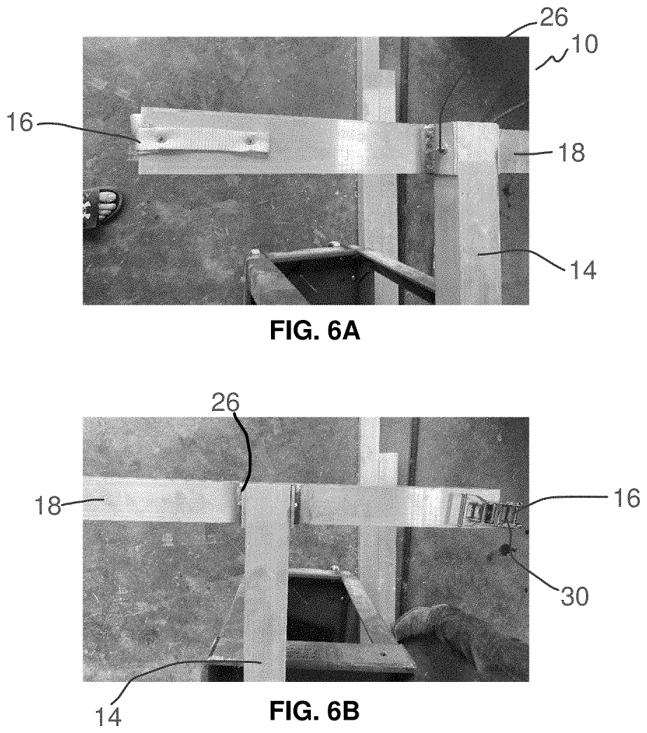

Turning now to FIGS. 6A and 6B, the retention device 16 discussed above is discussed in further detail according to one embodiment. A retention device 16 or devices 16 can be affixed to the vertical support 14 and/or horizonal support 18. In the exemplary implementation of FIGS. 6A-B, the retention device 16 is affixed to the horizontal support 18. In various implementations, the retention device 16 is a strap 16. In various implementations, as best shown in FIG. 6A, a first end of the strap 16 is fixedly attached to the horizontal support 18, such as via one or more pins, bolts, or other attachment mechanism, as would be appreciated.

In these and other implementations, as best shown in FIG. 6B, a lock 30 or other type of known detachable attachment mechanism is coupled to the horizontal support 18 opposite the attachment of the strap 20. In various implementations, the lock 30 receives the strap 28 to releasably hold the strap 28. In various implementations, the detachable attachment mechanism 30 may include a ratchet, a cam strap, a hook and loop mechanism, a buckle, Velcro, or other known attachment mechanism 30 type, as would be appreciated. The lock 30 is constructed and arranged to secure the strap 20 and thereby hold the kayak 8 or other item in place on the storage apparatus 10.

FIG. 7 shows an exemplary embodiment of the storage apparatus 10 in use. The storage apparatus 10 can be, according to various embodiments, coupled to a dock 6 or other structure or location via one or more bolts, as will discussed further herein. In certain implementations, the storage apparatus 10 is coupled to a dock 6 via the cradle 12 and/or vertical support 14 so as to suspend the storage apparatus 10 above water 4, at least in part. That is, the storage apparatus 10 is disposed on or outside the perimeter of the dock 6 such that the apparatus 10 and the retained item 8 is positioned above the water 4 instead of the surface of the dock 6. In certain implementations, the cradle 12 is coupled with the side 6A of a dock 6 such that the cradle 12 extends out over the water 4.

In use, in certain implementations, one end of a kayak 8 is may be disposed through the opening 20 in the box cradle 12. For example, the kayak 8 may be supported by the cradle 12 at the stern. The kayak 8 is then secured with the retention device 16, such as the strap 16. The strap 16 may extend around the kayak 8 and attach to the lock 30. The kayak 8 may then be held in place on the storage apparatus 10 for an indefinite period of time without impeding dock 6 space or without transporting the kayak 8 to a secondary location off of the dock 6 and away from the water 4.

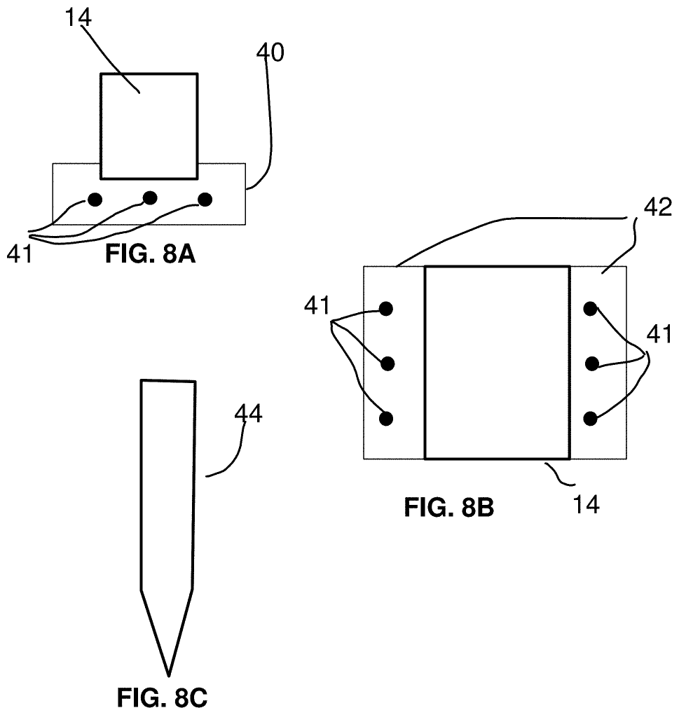

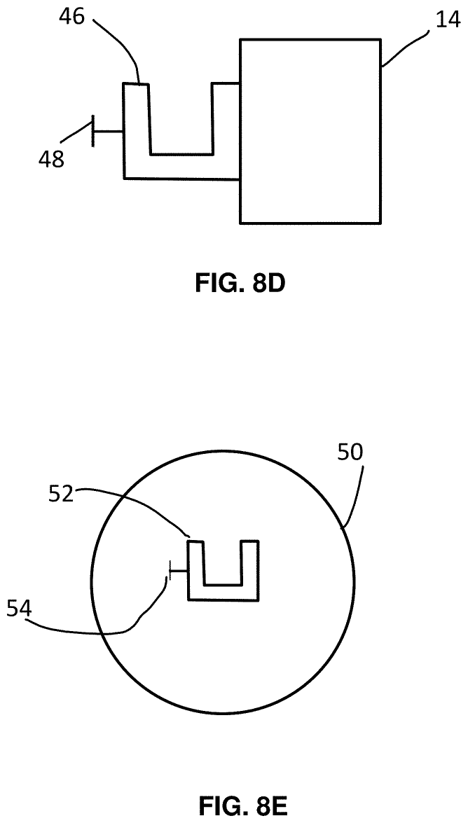

Turning now to FIGS. 8A-E, various attachment mechanisms and/or anchors are possible for affixing to or holding the storage apparatus 10 in a desired location. FIG. 8A shows an exemplary dock anchor where the vertical member 14 is affixed to a dock, as described above, via a bracket 40 having one or more openings through which one or more bolts 41 or other fasteners 41 can be inserted to temporarily or permanently affix the storage apparatus 10 to a dock.

Alternatively, the storage apparatus 10 may be affixed to a wall in much the same manner as affixing to a dock. As shown in FIG. 8B a bracket 42 or brackets 42 are disposed on/around the vertical member 14 and one or more bolts 41 or other fasteners 41 are inserted thought openings in the bracket 42 to affix the storage apparatus 10 to a wall, as would be appreciated.

In a further implementation, the storage apparatus 10 may be placed on a beach or in sand/dirt/earth via a stake 44, shown in FIG. 8C. In these and other implementations, the stake 44 is attached at a distal end/cradle 12 end of the vertical member 14 and driven into the sand/dirt/earth to support the storage apparatus 10.

In a still further implementation, the storage apparatus 10 includes an edge anchor 46 shown in FIG. 8D. In this implementation the storage device 10 may be affixed to the edge of horizontal surface, such as a dock or other surface as would be understood, via an opening and bolt 48 configuration or frictional hold, as would be understood.

In another implementation, the storage apparatus 10 is configured to be free standing, as shown in FIG. 8E. In these implementations, the vertical support is inserted into a bracket 52 and held by an opening and bolt 54 configuration, frictional hold, or other appropriate mechanism as would be appreciated, to a support plate 50. In these implementations, the support plate 50 is of sufficient size and weight to provide stable support for the storage apparatus 10 when the storage apparatus 10 is loaded with an intended item.

Although the various embodiments have been described with reference to preferred implementations, persons skilled in the art will recognize that changes may be made in form and detail without departing from the spirit and scope thereof.

What is claimed is:

1. A storage apparatus comprising:
(a) a cradle defining an opening;
(b) a vertical support having a first end and a second end, where the first end of the of the vertical support is attached to the cradle; and
(c) a horizontal support, where the horizontal member is attached to the vertical support at the second end of the vertical support,
wherein the cradle is configured to hold an item for storage.

2. The storage apparatus of claim 1, further comprising a retention device operatively engaged with the horizontal support, wherein the retention device is configured to encircle the stored item and hold the stored item against the horizontal support.

3. The storage apparatus of claim 2, wherein the retention device comprises a ratchet strap.

4. The storage apparatus of claim 1, wherein the vertical support is a telescoping member.

5. The storage apparatus of claim 1, wherein the cradle, the vertical support, and the horizontal support are modular and configured for releasable engagement with each other.

6. The storage apparatus of claim 1, wherein the cradle, the vertical support, and the horizontal support are unitary.

7. The storage apparatus of claim 1, further comprising a bumper disposed on the horizontal support.

8. The storage apparatus of claim 1, further comprising a liner disposed on the cradle.

9. The storage apparatus of claim 1, further comprising at least one of a dock anchor, a wall anchor, a sand stake, an edge anchor, and a free-standing support for engagement with the vertical support.

10. A storage apparatus comprising:
(a) an elongate member;
(b) a cradle engaged with the elongate member at a first end;
(c) a first horizontal member engaged with the elongate member at a second end; and
(d) at least one attachment anchor,
wherein the cradle, first horizontal member, and elongate member are configured to hold a secured item for storage.

11. The storage apparatus of claim 10, wherein the cradle is slidably engaged with the elongate member to be capable of being disposed along the first end at two or more elevations.

12. The storage apparatus of claim 10, wherein the first horizontal member is slidably engaged with the elongate member to be capable of being disposed along the second end at two or more elevations.

13. The storage apparatus of claim 10, further comprising a second horizonal member engaged with the elongate member between the first horizonal member and the cradle.

14. The storage apparatus of claim 10, further comprising a retention device engaged with the first horizontal member, wherein the retention device is configured to encircle the secured item and hold the secured item against the horizontal member.

15. The storage apparatus of claim 14, wherein the first horizontal member further comprises a bumper, wherein the bumper is disposed between the horizontal member and the secured item to protect the secured item.

16. The storage apparatus of claim 10, wherein the attachment anchor is a dock anchor and wherein the storage apparatus is configured to be fixedly attached to a side of a dock.

17. The storage apparatus of claim 10, wherein the cradle further comprises a liner.

18. The storage apparatus of claim 10, wherein the retention device comprises at least one of a ratchet strap, a cam strap, a hook and loop mechanism, a buckle, and Velcro.

19. The storage apparatus of claim 10, wherein the retention device comprises a ratchet strap.

20. A storage device for securing an item comprising:
(a) an elongate vertical member;
(b) a cradle operatively engaged at a first end of the elongate vertical member, the cradle comprising a liner for cushioning the item when the item is secured in the cradle;
(c) a horizontal member operatively engaged at a second end of the elongate vertical member, the horizontal member comprising a cushion for cushioning the item when the item is against the horizontal member;
(d) a retention device disposed on the horizontal member configured to encircle the item when the item is in the cradle and against the horizontal member; and
(e) a dock anchor operatively engaged with the storage device configured for securing the storage device to a docket via one or more fasteners.
